(19) United States
(12) Patent Application Publication
(10) Pub. No.: US 2025/0349893 A1
(43) Pub. Date: Nov. 13, 2025

(54) Electrolyte for Lithium Secondary Battery and Lithium Secondary Battery Including the Same

(71) Applicants: SK On Co., Ltd., Seoul (KR); SK Innovation Co., Ltd., Seoul (KR)

(72) Inventors: Ki Sung PARK, Daejeon (KR); Min Hee LEE, Daejeon (KR); Sang Hye SHIN, Daejeon (KR); In Haeng CHO, Daejeon (KR)

(21) Appl. No.: 19/202,364

(22) Filed: May 8, 2025

(30) Foreign Application Priority Data
May 13, 2024 (KR) 10-2024-0062524

(51) Int. Cl. H01M 10/0567; H01M 4/02; H01M 4/38; H01M 4/525; H01M 4/583; H01M 10/052; H01M 10/0568; H01M 10/0569

(52) U.S. Cl. CPC H01M 10/0567; H01M 4/386; H01M 4/525; H01M 4/583; H01M 10/052; H01M 10/0568; H01M 10/0569; H01M 2004/027; H01M 2004/028; H01M 2300/0037

(57) ABSTRACT

An electrolyte for the lithium secondary battery according to embodiments of the present disclosure includes an additive including a complex containing a boroxine compound, a lithium salt and an organic solvent. Accordingly, a lithium secondary battery including the electrolyte for a lithium secondary battery exhibits improved high-temperature storage characteristics and cycle life characteristics.

### CROSS-REFERENCE TO RELATED APPLICATION AND CLAIM OF PRIORITY

This application claims priority to Korean Patent Application No. 10-2024-0062524 filed on May 13, 2024 in the K orean Intellectual Property Office (KIPO), the entire disclosure of which is incorporated by reference herein.

### BACKGROUND

### 1. Field

The embodiments of the present disclosure generally relate to an electrolyte for a lithium secondary battery and a lithium secondary battery including the same, and more specifically, to an electrolyte for a lithium secondary battery, which includes a solvent and an electrolyte salt, and a lithium secondary battery including the electrolyte.

### 2. Description of the Related Art

A secondary battery is a battery that can be repeatedly charged and discharged, and has been widely applied to portable electronic devices such as a mobile phone, a laptop computer, etc. as their power sources. Among the secondary batteries, a lithium secondary battery has a high operating voltage and a high energy density per unit weight, making it advantageous in terms of charging speed and lightweight design. In this regard, the lithium secondary battery has been actively developed and applied to various industrial fields.

The lithium secondary battery may include: for example, an electrode assembly including a cathode, an anode and a separation membrane interposed between the cathode and the anode; and an electrolyte in which the electrode assembly is impregnated.

The lithium secondary battery may further include, for example, a pouch-type outer case in which the electrode assembly and the electrolyte are housed.

The cathode of a lithium secondary battery may be prepared by, for example, applying a cathode slurry including a cathode active material, a binder, and further including a conductive material to a cathode current collector, followed by drying and pressing the same.

When the lithium secondary battery is repeatedly charged and discharged, side reactions may occur between the cathode active material and the electrolyte, which can degrade the stability and cycle life characteristics of the lithium secondary battery.

### SUMMARY

An object of the present disclosure is to provide an electrolyte for a lithium secondary battery with improved high-temperature storage characteristics and cycle life characteristics.

Another object of the present disclosure is to provide a lithium secondary battery including the electrolyte with improved high-temperature storage characteristics and cycle life characteristics.

An electrolyte for a lithium secondary battery according to exemplary embodiments may include: an additive which includes a complex containing a boroxine compound: a lithium salt; and an organic solvent.

In some embodiments, the boroxine compound may include a compound having a structure represented by Formula 1 below.

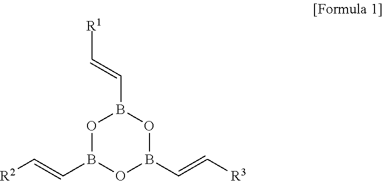

In Formula 1, R¹ to R³ may each be independently an alkyl group having 1 to 10 carbon atoms, an alkenyl group having 2 to 10 carbon atoms, an alkoxy group having 1 to 10 carbon atoms, an aryl group having 6 to 12 carbon atoms, a hydroxyl group or a hydrogen atom.

In some embodiments, R¹ to R³ may each be independently an alkyl group having 1 to 6 carbon atoms, an alkenyl group having 2 to 6 carbon atoms, an alkoxy group having 1 to 6 carbon atoms, an aryl group having 6 to 10 carbon atoms, a hydroxyl group or a hydrogen atom.

In some embodiments, the compound having a structure represented by Formula 1 above may include a compound having a structure represented by Formula 2 below.

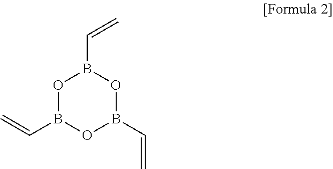

In some embodiments, the complex may further include a heteroaromatic amine which is bonded to the boroxine compound.

In some embodiments, the heteroaromatic amine may include pyridine.

In some embodiments, the complex may include a complex having a structure represented by Formula 3 below.

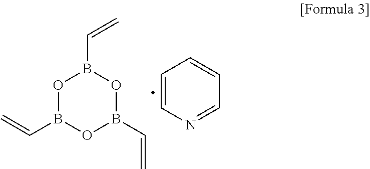

In some embodiments, the organic solvent may include at least one selected from the group consisting of a carbonate-based organic solvent, an ester-based organic solvent, an ether-based organic solvent, a ketone-based organic solvent and an aprotic organic solvent.

In some embodiments, a content of the additive may be 0.1% by weight to 10% by weight based on a total weight of the electrolyte.

In some embodiments, the electrolyte may further include at least one auxiliary additive selected from the group consisting of a cyclic carbonate compound, a fluorine-containing carbonate compound, a lithium phosphate compound, a sultone compound, a borate compound and a sulfate compound.

In some embodiments, a content of the auxiliary additive may be 0.01% by weight to 10% by weight based on the total weight of the electrolyte.

In some embodiments, the electrolyte may further include an auxiliary additive including a sultone compound and a sulfate compound.

A lithium secondary battery according to exemplary embodiments may include: an electrode assembly which includes cathodes and anodes repeatedly stacked; and the above-described electrolyte for a lithium secondary battery, which is impregnated into the electrode assembly.

In some embodiments, the cathode may include a cathode active material including a lithium metal oxide-based active material.

In some embodiments, the anode may include an anode active material including a silicon-based active material.

The electrolyte for a lithium secondary battery according to exemplary embodiments may form a stable solid electrolyte interphase (SEI) on the electrode surface. Accordingly, a lithium secondary battery including the electrolyte for a lithium secondary battery may exhibit improved high-temperature storage characteristics and cycle life characteristics.

The electrolyte may be widely applied in green technology fields, such as electric vehicles, battery charging stations, as well as solar power generation, wind power generation, and the like, which use the batteries. In addition, the lithium secondary battery may be used in eco-friendly electric vehicles, hybrid vehicles, and the like, which are aimed at mitigating climate change by reducing air pollution and greenhouse gas emission.

### BRIEF DESCRIPTION OF THE DRAWINGS

The above and other objects, features and other advantages of the embodiments of the present disclosure will be more clearly understood from the following detailed description taken in conjunction with the accompanying drawings, in which:

FIG. 1 is a plan view schematically illustrating a lithium secondary battery according to embodiments of the present disclosure; and

FIG. 2 is a cross-sectional view schematically illustrating the lithium secondary battery according to embodiments of the present disclosure.

### DETAILED DESCRIPTION

An electrolyte for a lithium secondary battery according to exemplary embodiments may include an additive including a complex containing a boroxine compound, a lithium salt and an organic solvent.

In addition, the lithium secondary battery according to exemplary embodiments may include: an electrode assembly including cathodes and anodes repeatedly stacked; and an electrolyte for a lithium secondary battery, which is impregnated into the electrode assembly.

Accordingly, the high-temperature storage characteristics and cycle life characteristics of the lithium secondary battery may be improved.

As used herein, the “A compound” may refer to a compound including an A unit attached to a matrix, etc. of the “A compound” and a derivative thereof.

As used herein, the “carbon-based active material” may refer to a material that includes carbon but does not include silicon.

As used herein, the “silicon-based active material” may refer to a material that includes silicon.

Hereinafter, the embodiments of the present disclosure will be described in detail. However, these embodiments are merely examples, and the present disclosure is not limited to the specific embodiments described as example.

### Electrolyte for a Lithium Secondary Battery

The electrolyte for a lithium secondary battery (hereinafter, also abbreviated as the electrolyte) according to exemplary embodiments may include an additive including a complex containing a boroxine compound, a lithium salt and an organic solvent.

Hereinafter, the components of the present disclosure will be described in more detail.

### Additive

The electrolyte for a lithium secondary battery according to exemplary embodiments may include an additive including a complex containing a boroxine compound.

In some embodiments, the complex containing the boroxine compound may be formed by a coordination bond between the boroxine compound, which is a Lewis acid, and a Lewis base. For example, the Lewis base may include a heteroaromatic amine such as pyridine.

In some embodiments, the complex may have the form of a coordination compound formed by an interaction, for example, a coordination bond, between the boroxine compound and the heteroaromatic amine.

In some embodiments, the boroxine compound may include a compound having a structure represented by Formula 1 below.

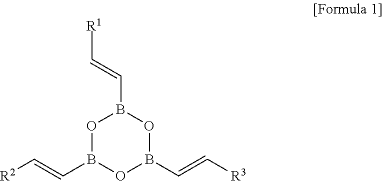

In Formula 1, R¹ to R³ may each be independently an alkyl group having 1 to 10 carbon atoms, an alkenyl group having 2 to 10 carbon atoms, an alkoxy group having 1 to 10 carbon atoms, an aryl group having 6 to 12 carbon atoms, a hydroxyl group or a hydrogen atom.

For example, R¹ to R³ may each be independently an alkyl group having 1 to 6 carbon atoms, an alkenyl group having 2 to 6 carbon atoms, an alkoxy group having 1 to 6 carbon atoms, an aryl group having 6 to 10 carbon atoms, a hydroxyl group or a hydrogen atom.

For example, R¹ to R³ may each be independently an alkyl group having 1 to 3 carbon atoms, an alkenyl group having 2 to 4 carbon atoms, an alkoxy group having 1 to 3 carbon atoms, an aryl group having 6 to 8 carbon atoms, a hydroxyl group or a hydrogen atom.

For example, R¹ to R³ may each be independently a methyl group, a vinyl group, a methoxy, a phenyl group, a hydroxyl group or a hydrogen atom.

For example, all of R¹ to R³ may be hydrogen atoms.

In some embodiments, the compound having a structure represented by Formula 1 above may include a compound having a structure represented by Formula 2 below.

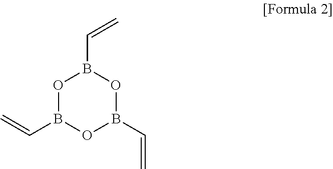

In some embodiments, the complex may further include a heteroaromatic amine which is bonded to the boroxine compound.

In some embodiments, the heteroaromatic amine may include pyridine.

In some embodiments, the complex may include a complex having a structure represented by Formula 3 below.

For example, the complex may have a structure represented by Formula 3 below.

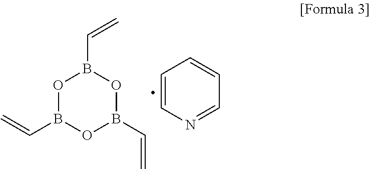

For example, when an additive containing the complex is included in the electrolyte, a solid electrolyte interphase film having a stable structure may be formed on the electrode surface. By stably protecting the electrode surface, the film may stabilize the electrode interface and suppress side reactions between the electrode active material and the electrolyte.

For example, a coordination covalent bond may be formed by the donation of a lone pair of electrons on the nitrogen atom of pyridine, which is a Lewis base, to a vacant orbital on the boron atom in the boroxine compound, which is a Lewis acid, thereby forming the complex.

For example, pyridine may be protonated under acidic conditions, thereby functioning as an HF scavenger and suppressing the decomposition of the solid electrolyte interphase (SEI) and the generation of hydrogen gas. Accordingly, the electrolyte may be stabilized to improve the high-temperature storage characteristics and high-temperature cycle life characteristics of the battery.

For example, in the boroxine compound, the electron-deficient boron atom may readily bond with an anion, thereby facilitating the formation of a solid electrolyte interphase rich in inorganic substances, and suppressing electrolyte decomposition and gas generation by capturing oxygen radicals. Accordingly, the cycle life characteristics of the battery may be improved.

In some embodiments, a content of the additive may be 0.1% by weight (“wt %”) to 10 wt % based on the total weight of the electrolyte.

For example, the content of the additive may be 0.2 wt % to 8 wt %, 0.3 wt % to 5 wt %, 0.4 wt % to 3 wt %, 0.5 wt % to 2 wt %, 0.1 wt % to 1 wt %, 0.3 wt % to 1 wt %, or 0.5 wt % to 1 wt % based on the total weight of the electrolyte.

Within the above range, a solid electrolyte interphase film having a stable structure may be formed, and the migration of lithium ions and the activity of the cathode active material may not be inhibited.

### Auxiliary Additive

The electrolyte for the lithium secondary battery according to exemplary embodiments may further include at least one auxiliary additive selected from the group consisting of a cyclic carbonate compound, a fluorine-containing carbonate compound, a lithium phosphate compound, a sultone compound, a borate compound and a sulfate compound.

In some embodiments, the electrolyte may further include an auxiliary additive including a sultone compound and a sulfate compound, and for example, may further include an auxiliary additive consisting of a sultone compound and a sulfate compound.

When the additive and the auxiliary additive are used in combination, a lithium secondary battery with further improved high-temperature storage characteristics and cycle life characteristics may be efficiently implemented.

For example, the cyclic carbonate compound may include vinylene carbonate (VC), vinyl ethylene carbonate (VEC), etc.

For example, the fluorine-containing carbonate compound may include a fluorine atom bonded to at least one carbon atom of the carbonate compound or a substituent to which the fluorine atom is bonded (for example, a fluorine-substituted alkyl group such as —CF₃).

In some embodiments, the fluorine-containing carbonate compound may include a fluorine-containing cyclic carbonate compound having a cyclic structure. For example, the fluorine-containing cyclic carbonate compound may have a 5-to 7-membered cyclic structure.

For example, the fluorine-containing cyclic carbonate compound may include fluoroethylene carbonate (FEC).

In some embodiments, the lithium phosphate compound may include a fluorine-containing lithium phosphate compound.

For example, the fluorine-containing lithium phosphate compound may include a fluorine atom bonded to a phosphorus atom of the lithium phosphate compound or a substituent to which the fluorine atom is bonded (for example, a fluorine-substituted alkyl group such as CF₃).

In some embodiments, the fluorine-containing lithium phosphate compound may include at least one selected from the group consisting of lithium difluoro phosphate (LiPO₂F₂) and lithium difluoro (bis-oxalato) phosphate. For example, the fluorine-containing lithium phosphate compound may include lithium difluoro phosphate (LiPO₂F₂).

In some embodiments, the sultone compound may include at least one selected from the group consisting of an alkyl sultone compound and an alkenyl sultone compound.

In some embodiments, the sultone compound may include both an alkyl sultone compound and an alkenyl sultone compound.

For example, the alkyl sultone compound may include at least one selected from the group consisting of 1,3-propane sultone (PS) and 1,4-butene sultone.

For example, the alkenyl sultone compound may include at least one selected from the group consisting of ethene sultone, 1,3-propene sultone (PRS), 1,4-butene sultone and 1-methyl-1,3-propene sultone.

In some embodiments, the sulfate compound may include a cyclic sulfate compound having a cyclic structure. The cyclic sulfate compound may have a 5- to 7-membered cyclic structure.

For example, the cyclic sulfate compound may include at least one selected from the group consisting of 1,2-ethylene sulfate (ESA), trimethylene sulfate (TMS) and methyltrimethylene sulfate (MTMS).

For example, the cyclic sulfite compound may include ethylene sulfite, butylene sulfite, and the like.

For example, the borate compound may include lithium bis(oxalate) borate.

In some embodiments, the electrolyte may further include an auxiliary additive including 1,3-propane sultone and 1,2-ethylene sulfate, and may further include, for example, an auxiliary additive consisting of 1,3-propane sultone and 1,2-ethylene sulfate.

In some embodiments, a content of the auxiliary additive may be 0.01 wt % to 10 wt % based on the total weight of the electrolyte.

For example, the content of the auxiliary additive may be 0.05 wt % to 9 wt %, 0.1 wt % to 8 wt %, 0.2 wt % to 7 wt %, 0.3 wt % to 6 wt %, 0.4 wt % to 5 wt %, or 0.5 wt % to 4 wt % based on the total weight of the electrolyte.

Within the above range, the durability of the solid electrolyte interface may be enhanced without inhibiting the role of the additive.

In some embodiments, a ratio of the weight of the auxiliary additive to the weight of the additive in the electrolyte may be 0.1 to 10.

For example, the weight ratio may be 0.2 to 9, 0.3 to 8, 0.4 to 7, or 0.5 to 5. Within the above range, the high-temperature storage characteristics and cycle life characteristics of the lithium secondary battery may be further improved.

In some embodiments, the auxiliary additive may further include at least one selected from the group consisting of a borate compound, a nitrile compound, an amine compound, a silane compound and a benzene compound.

For example, the borate compound may include at least one selected from the group consisting of lithium tetraphenyl borate and lithium difluoro (oxalato) borate (LiODFB).

For example, the nitrile compound may include at least one selected from the group consisting of succinonitrile, adiponitrile, acetonitrile, propionitrile, butyronitrile, valeronitrile, caprylonitrile, heptanenitrile, cyclopentane carbonitrile, cyclohexane carbonitrile, 2-fluorobenzonitrile, 4-fluorobenzonitrile, difluorobenzonitrile, trifluorobenzonitrile, phenylacetonitrile, 2-fluorophenylacetonitrile and 4-fluorophenylacetonitrile.

For example, the amine compound may include at least one selected from the group consisting of triethanolamine and ethylene diamine fluorophenylacetonitrile.

For example, the silane compound may include tetravinyl silane, etc.

For example, the benzene compound may include at least one selected from the group consisting of monofluorobenzene, difluorobenzene, trifluorobenzene and tetrafluorobenzene.

### Organic Solvent and Lithium Salt

For example, the organic solvent may include an organic compound which provides sufficient solubility to the lithium salt, the additive and the auxiliary additive, and does not chemically react within the lithium secondary battery.

In some embodiments, the organic solvent may include at least one selected from the group consisting of a carbonate solvent, an ester solvent, an ether solvent, a ketone solvent, an alcohol solvent and an aprotic solvent.

In some embodiments, the organic solvent may include a carbonate solvent, and the carbonate solvent may include a linear carbonate solvent and a cyclic carbonate solvent.

For example, the linear carbonate solvent may include dimethyl carbonate (DMC), ethyl methyl carbonate (EMC), diethyl carbonate (DEC), methyl propyl carbonate, ethyl propyl carbonate, dipropyl carbonate and the like.

For example, the cyclic carbonate solvent may include ethylene carbonate (EC), propylene carbonate (PC), butylene carbonate and the like.

In some embodiments, the organic solvent may include the linear carbonate solvent in a greater volume than the cyclic carbonate solvent based on a volume.

In some embodiments, a ratio of the volume of the cyclic carbonate solvent to the volume of the linear carbonate solvent in the organic solvent may be 1/9 to 1. For example, the volume ratio may be 1/9 to 1, 1/9 to ⅔, ⅙ to ⅔, or ¼ to ⅔. Within the above range, the high-temperature storage characteristics of the lithium secondary battery may be further improved.

For example, the ester solvent may include at least one of methyl acetate (MA), ethyl acetate (EA), n-propyl acetate (n-PA), 1,1-dimethylethyl acetate (DM EA), methyl propionate (MP), ethyl propionate (EP), γ-butyrolactone (GBL), decanolide, valerolactone, mevalonolactone and caprolactone.

For example, the ether solvent may include at least one of dibutyl ether, tetraethylene glycol dimethyl ether (TEGDME), diethylene glycol dimethyl ether (DEGDME), dimethoxyethane, tetrahydrofuran (THF) and 2-methyltetrahydrofuran.

For example, the ketone solvent may include cyclohexanone, etc.

For example, the alcohol solvent may include at least one of ethyl alcohol and isopropyl alcohol.

For example, the aprotic solvent may include at least one of a nitrile solvent, an amide solvent (e.g., dimethylformamide), a dioxolane solvent (e.g., 1,3-dioxolane), and a sulfolane solvent.

In some embodiments, the electrolyte may include a lithium salt

The above lithium salt is represented by Li⁺X⁻, and as an anion (X) of the lithium salt, F⁻, Cl⁻, Br⁻, I⁻, NO₃⁻, N(CN)₂⁻, BF₄⁻, ClO₄⁻, PF₆⁻, (CF₃)₂PF₄⁻, (CF₃)₃PF₃, (CF₃)₄PF₂⁻, (CF₃)₅PF⁻, (CF₃)₆P⁻; CF₃SO₃⁻, CF₃CF₂SO₃⁻, (CF₃SO₂)₂N⁻, (FSO₂)₂N⁻, CF₃CF₂(CF₃)₂CO⁻, (CF₃SO₂)₂CH⁻, (SF₅)₃C⁻, (CF₃SO₂)₃C⁻, CF₃(CF₂)₇SO₃⁻, CF₃CO₂⁻, CH₃CO₂⁻, ⁻ SCN and (CF₃CF₂SO₂)₂N⁻, etc. may be exemplified.

In some embodiments, the lithium salt may include at least one selected from the group consisting of LiPF₆, LiClO₄, LiBF₄, LiFSl, LiTFSl, LiSO₃CF₃, LiBOB, LiFOB, LiDFOB, LiDFBP, LiTFOP, LiPO₂F₂, LiCl, LiBr, LiI, LiB₁₀Cl₁₀, LiCF₃SO₃, LiCF₃CO₂, LiAsF₆, LiSbF₆, LiAlCl₄, CH₃SO₃Li, CF₃SO₃Li, LiSCN and LiC(CF₃SO₂)₃.

In one embodiment, the lithium salt may include at least one selected from the group consisting of LiPF₆, LiFSI and LiTFSI.

In some embodiments, the lithium salt may be included in the organic solvent at a concentration of 0.01 M to 5 M, 0.01 M to 4 M, 0.5 M to 3 M, or 0.5 M to 2 M. Within the above concentration range, lithium ions and/or electrons may migrate smoothly during charging and discharging of the lithium secondary battery.

### Lithium Secondary Battery

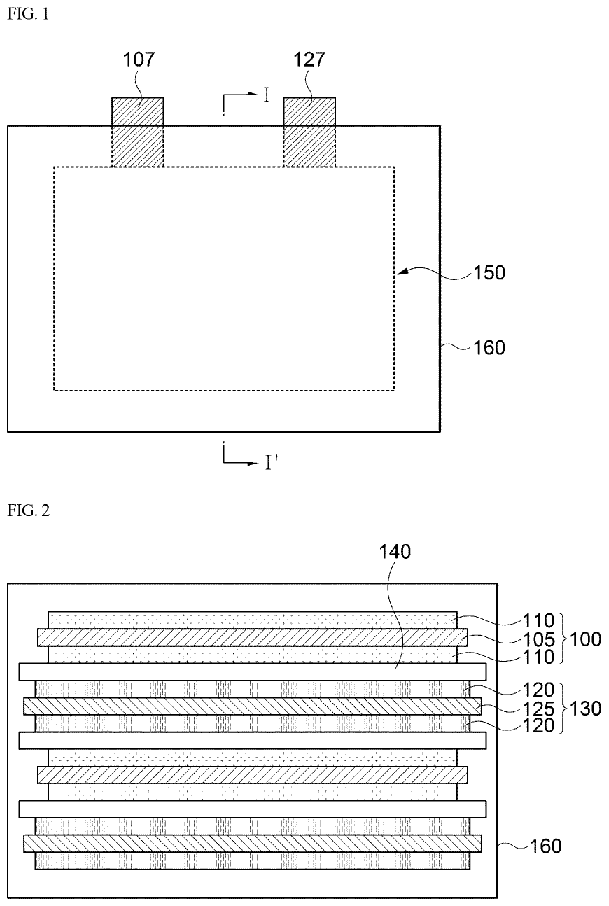

FIGS. 1 and 2 are schematic plan and cross-sectional views illustrating a lithium secondary battery according to exemplary embodiments, respectively. For example, FIG. 2 is a cross-sectional view taken on line I-I′ in FIG. 1.

The secondary battery structure illustrated in FIGS. 1 and 2 is schematically illustrated, and the secondary battery structure according to the disclosure of the present application is not limited thereto.

Referring to FIGS. 1 and 2, the lithium secondary battery may include an electrode assembly 150 including a cathode 100, an anode 130 and a separation membrane 140 interposed between the cathode and the anode.

For example, the electrode assembly 150 may include the cathodes 100 and the anodes 130, which are repeatedly stacked, and the electrode assembly 150 may be housed in a case 160 together with the electrolyte according to the above-described exemplary embodiments to be impregnated therein.

The cathode 100 may include a cathode current collector 105 and a cathode active material layer 110 disposed on at least one surface of the cathode current collector 105.

The cathode current collector 105 may include stainless steel, nickel, aluminum, titanium, or an alloy thereof. The cathode current collector may also include aluminum or stainless steel having a surface treated with carbon, nickel, titanium, or silver. The cathode current collector may have a thickness of 10 μm to 50 μm, but it is not limited thereto.

For example, the cathode active material may include a compound capable of reversibly intercalating and deintercalating lithium ions.

In some embodiments, the cathode may include a cathode active material including a lithium metal oxide-based active material. For example, the lithium metal oxide may include nickel (Ni), and may further include at least one selected from the group consisting of cobalt (Co) and manganese (Mn).

In some embodiments, the cathode active material may include lithium metal oxide particles having a structure represented by Formula 4 below.

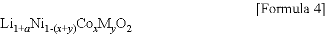

In the above Formula 4, a, x and y may satisfy −0.05≤a≤0.15, 0.01≤x<0.3, 0.01≤y≤0.3, and M may include at least one selected from the group consisting of Mn, Mg, Sr, Ba, B, Al, Si, Ti, Zr and W.

For example, nickel (Ni) may be provided as a metal associated with the capacity of the lithium secondary battery. The higher the content of nickel, the greater the improvement in capacity and output of the lithium secondary battery. However, if the content of nickel increases excessively, the cycle life of the lithium secondary battery may be reduced, and it may be disadvantageous in terms of mechanical and electrical stabilities.

In one embodiment, the conductivity or resistance of the lithium secondary battery may be improved by cobalt (Co), as well as the mechanical and electrical stabilities of the lithium secondary battery may be improved by manganese (Mn).

The chemical structure represented by Formula 4 above shows a bonding relationship between elements included in the lattice structure or crystal structure of the cathode active material, and does not exclude other additional elements.

In some embodiments, the cathode active material may include lithium metal phosphate particles having a structure represented by Formula 5 below.

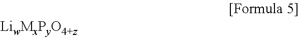

In Formula 5, w, x, y and z may satisfy 0.9≤w≤1.2,0.99≤x≤1.01,0.9≤y≤1.2,−0.1≤z≤0.1, and M may include at least one selected from the group consisting of Fe, Ni, Mn, Ti and V. For example, in Formula 5, M may be Fe, and the cathode active material may include a lithium iron phosphate (LFP) active material (e.g., LiFePO₄). The lithium iron phosphate (LFP) active material may have a stable olivine structure, and exhibit excellent long-term cycle life.

In some embodiments, the cathode active material may include a lithium metal oxide-based active material, a lithium manganese oxide-based active material, a lithium nickel oxide-based active material, or a lithium iron phosphate (LFP) active material (e.g., LiFePO₄).

In some embodiments, the cathode active material may include, for example, a manganese (Mn)-rich active material having a chemical structure or crystal structure represented by Formula 6 below, a lithium (Li)-rich layered oxide (LLO)/over lithiated oxide (OLO)-based active material, or a cobalt (Co)-less active material.

For example, the core of the active material may include a chemical structure or crystal structure represented by Formula 6 below.

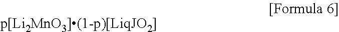

In Formula 6, p and q may satisfy 0<p<1, 0.9≤q≤1.2, and J may include at least one element among Mn, Ni, Fe, Cr, V, Cu, Zn, Ti, Al, Mg and B.

For example, the cathode active material may be dispersed in a solvent to prepare a cathode slurry. The cathode current collector 105 may be coated with the cathode slurry, and then dried and pressed to prepare the cathode 100. The coating process may be performed using methods such as gravure coating, slot die coating, simultaneous multilayer die coating, imprinting, doctor blade coating, dip coating, bar coating or casting, etc., but it is not limited thereto. The cathode slurry may further include a binder, and optionally further include a conductive material, a thickener or the like.

Non-limiting examples of a solvent used in the preparation of the cathode slurry may include N-methyl-2-pyrrolidone (NMP), dimethylformamide, dimethylacetamide, N,N-dimethylaminopropylamine, ethylene oxide, tetrahydrofuran and the like.

The binder may include polyvinylidene fluoride (PVDF), polyvinylidene fluoride-co-hexafluoropropylene, polyacrylonitrile, polymethylmethacrylate, acrylonitrile butadiene rubber (NBR), polybutadiene rubber (BR), styrene-butadiene rubber (SBR) and the like. In one embodiment, a PV DF-based binder may be used as the cathode binder.

The conductive material may be added to enhance the conductivity of the cathode slurry layer and/or the mobility of lithium ions or electrons. For example, the conductive material may include a carbon-based conductive material such as graphite, carbon black, acetylene black, K etjen black, graphene, carbon nanotubes (CNTs), vapor-grown carbon fibers (VGCFs), carbon fibers, and/or a metal-based conductive material including tin, tin oxide, titanium oxide, or a perovskite material such as LaSrCoO₃, and LaSrM nO₃.

As the thickener, for example, carboxymethyl cellulose (CMC) may be used.

The anode 130 may include an anode current collector 125 and an anode active material layer 120 disposed on at least one surface of the anode current collector 125.

For example, non-limiting examples of the anode current collector 125 may include a copper foil, a nickel foil, a stainless steel foil, a titanium foil, a nickel foam, a copper foam, a polymer substrate coated with conductive metal and the like. The anode current collector may have a thickness of 10 μm to 50 μm, but it is not limited thereto.

The anode slurry layer may include an anode active material. A material capable of intercalating and deintercalating lithium ions may be used as the anode active material.

In some embodiments, the anode may include an anode active material including a silicon-based active material. The silicon-containing active material may provide increased capacity characteristics.

For example, the silicon-based active material may include at least one selected from the group consisting of a carbon-silicon composite active material, silicon oxide (SiOₓ, 0<x<2), and pure silicon.

For example, the carbon-silicon composite active material may include carbon-based particles having micropores and a silicon coating formed on the inside and/or surface of the carbon-based particles. The carbon-based particles may include activated carbon, carbon nanotubes, carbon nanowires, graphene, carbon fibers, carbon black, graphite, porous carbon, pyrolyzed cryogel, pyrolyzed xerogel, and pyrolyzed aerogel.

In some embodiments, the anode active material may include carbon-based materials such as crystalline carbon, amorphous carbon, carbon fibers, etc.; lithium metal; a lithium alloy; or a tin (Sn)-containing material.

Examples of the amorphous carbon include hard carbon, soft carbon, cokes, mesocarbon microbeads (MCMBs), mesophase pitch-based carbon fibers (MPCF), etc.

Examples of the crystalline carbon include graphite-based carbon such as natural graphite, artificial graphite, graphitized coke, graphitized MCMB, and graphitized MPCF.

The lithium metal may include pure lithium metal or lithium metal having a protective layer formed thereon for suppressing dendrite growth, etc. In one embodiment, a lithium metal-containing layer deposited or coated on the anode current collector may be used as the anode active material layer. In one embodiment, a lithium thin film layer may be used as the anode active material layer.

E lements included in the lithium alloy may include aluminum, zinc, bismuth, cadmium, antimony, silicon, lead, tin, gallium or indium, etc.

For example, the anode active material may be dispersed in a solvent to prepare an anode mixture. The anode current collector may be coated with the anode mixture, and then dried and pressed to prepare an anode. The coating process may be performed using methods such as gravure coating, slot die coating, simultaneous multilayer die coating, imprinting, doctor blade coating, dip coating, bar coating or casting, etc., but it is not limited thereto. The anode slurry may further include a binder, and optionally further include a conductive agent, a thickener or the like.

In some embodiments, the anode may include an anode active material layer in the form of a lithium metal formed through a deposition/coating process.

Non-limiting examples of the solvent for the anode slurry may include water, pure water, deionized water, distilled water, ethanol, isopropanol, methanol, acetone, n-propanol, t-butanol and the like.

The above-described materials that can be used when preparing the cathode as the binder, conductive material and thickener may be used.

For example, as the anode binder, a styrene-butadiene rubber (SBR)-based binder, a polyacrylic acid-based binder, a poly(3,4-ethylenedioxythiophene, PEDOT)-based binder, etc., may be used, which may be used in combination with a thickener such as carboxymethyl cellulose (CMC).

In some embodiments, the separation membrane 140 may be interposed between the cathode 100 and the anode 130. The separation membrane may prevent electrical short-circuit between the cathode and the anode, and maintain flow of ions. According to an embodiment, the separation membrane may have a thickness of 10 μm to 20 μm, but in the present disclosure, it is not limited thereto.

The separation membrane may include a porous polymer film or a porous nonwoven fabric. The porous polymer film may include a polyolefin-based polymer such as an ethylene polymer, a propylene polymer, an ethylene/butene copolymer, an ethylene/hexene copolymer, and an ethylene/methacrylate copolymer, etc. The porous nonwoven fabric may include glass fibers having a high melting point, polyethylene terephthalate fibers, etc.

The separation membrane may also include a ceramic-based material. For example, inorganic particles may be applied to the polymer film or dispersed within the polymer film to improve heat resistance.

The separation membrane may have a single-layer or multi-layer structure including the above-described polymer film and/or non-woven fabric.

According to exemplary embodiments, the cathode 100, the anode 130 and the separation membrane 140 may be repeatedly disposed to form an electrode assembly 150. In some embodiments, the electrode assembly 150 may have a jelly roll shape formed by winding, stacking, z-folding, or stack-folding the separation membrane 140.

In some embodiments, the electrode assembly 150 may have a jelly roll shape formed by winding the cathode 100, the anode 130 and the separation membrane 140 together. In some embodiments, the electrode assembly 150 may have a jelly roll shape in which the notched cathodes and anodes are disposed in a space formed by repeatedly z-folding the separation membrane 140.

In some embodiments, the electrode assembly may be formed by repeatedly stacking the cathodes, anodes, and separation membranes with the respective layers being cut or separated from each other.

For example, electrode tabs (a cathode tab and an anode tab) may protrude from the cathode current collector 105 and the anode current collector 125, respectively, which belong to each electrode cell, and may extend to one side of the case 160. The electrode tabs may be fused together with the one side of the case 160 to form electrode leads (a cathode lead and an anode lead) that extend or are exposed to the outside of the case 160.

For example, a pouch-type case, a prismatic case, a cylindrical case, a coin-type case, etc. may be used to house the battery.

The electrode assembly 150 may be housed in the case 160 together with the electrolyte to define a lithium secondary battery.

Hereinafter, embodiments of the present disclosure will be further described with reference to specific experimental examples. However, the following examples and comparative examples included in the experimental examples are only given for illustrating the present disclosure and those skilled in the art will obviously understand that various alterations and modifications are possible within the scope and spirit of the present disclosure. Such alterations and modifications are duly included in the appended claims.

### Examples and Comparative Examples

### Example 1

### (1) Preparation of Electrolyte

A 1.1 M LiPF₆ solution (a mixed solvent of ethylene carbonate (EC)/ethyl methyl carbonate (EMC) in a volume ratio of 25:75) was prepared.

Based on the total weight (100 wt %) of the electrolyte, 5.0 wt % of fluoroethylene carbonate (FEC), 1.0 wt % of LiPO₂F₂, 0.5 wt % of 1,3-propane sultone (PS), and 0.5 wt % of 1,2-ethylene sulfate (ESA) were added to the LiPF₆ solution, and 0.5 wt % of additive I, which is a complex of a boroxine compound having a structure represented by Formula 3 below and pyridine (manufactured by TCI, Product No.: T 2498), was further added to prepare an electrolyte.

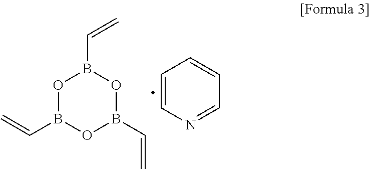

### (2) Manufacturing of Lithium Secondary Battery Sample

A cathode slurry was prepared by mixing and dispersing a cathode active material, in which Li[Ni_{0.88}Co_{0.06}Mn_{0.06}]O₂, carbon black as a conductive material, and polyvinylidene fluoride (PVdF) as a binder in a weight ratio of 92:5:3 in N-methyl-2-pyrrolidone (NMP).

The cathode slurry was uniformly applied to a region of an aluminum foil (thickness: 15 μm) having a protrusion part (cathode tab) on one side except for the protrusion part, and then dried and pressed to prepare a cathode.

A carbon-silicon composite active material was prepared by forming a carbon coating on silicon-based particles through a CVD process using methane as a carbon source gas. An anode slurry was prepared by mixing the prepared carbon-silicon composite active material as an anode active material, styrene-butadiene rubber (SBR) as a binder, and carboxymethyl cellulose (CMC) as a thickener in a weight ratio of 97:1:2 in distilled water.

The anode slurry was uniformly applied to a copper foil (thickness: 15 μm) having a protrusion part (anode tab) on one side, except for the protrusion part, and then dried and pressed to prepare an anode.

An electrode assembly was formed by interposing a polyethylene separation membrane (thickness: 15 μm) between the cathode and the anode. Next, a cathode lead and an anode lead were welded and connected to the cathode tab and the anode tab, respectively.

The electrode assembly was housed in a pouch (case) so that some regions of the cathode lead and the anode lead were exposed to the outside of the pouch, followed by sealing three sides of the pouch except for the side with an electrolyte injection port.

After injecting the electrolyte prepared in the above (1) and sealing the side of the electrolyte injection part, a lithium secondary battery was manufactured by allowing it to be impregnated for 14 hours.

### Example 2

An electrolyte and a lithium secondary battery sample were manufactured in the same manner as in Example 1, except that 0.3 wt % of additive I was used instead of 0.5 wt %.

### Example 3

An electrolyte and a lithium secondary battery sample were manufactured in the same manner as in Example 1, except that 1.0 wt % of additive I was used instead of 0.5 wt %.

### Comparative Example 1

An electrolyte and a lithium secondary battery sample were manufactured in the same manner as in Example 1, except that additive I was not used.

The electrolyte compositions of the examples and comparative examples are described in Table 1 below.

TABLE 1

| | Lithium | Additive | Auxiliary additive (wt %) | | | |
|---|---|---|---|---|---|---|
| | salt | (wt %) | FEC | LiPO₂F₂ | PS | ESA |
| Example 1 | LiPF₆ | Additive I | 5.0 | 1.0 | 0.5 | 0.5 |
| | (1.1M) | (0.5) | | | | |
| Example 2 | LiPF₆ | Additive I | 5.0 | 1.0 | 0.5 | 0.5 |
| | (1.1M) | (0.3) | | | | |
| Example 3 | LiPF₆ | Additive I | 5.0 | 1.0 | 0.5 | 0.5 |
| | (1.1M) | (1.0) | | | | |
| Comparative | LiPF₆ | — | 5.0 | 1.0 | 0.5 | 0.5 |
| Example 1 | (1.1M) | | | | | |

The components described in Table 1 are as follows.

Additive I: Complex of a boroxine compound having a structure represented by Formula 3 above and pyridine

FEC: Fluoroethylene carbonate

LiPO₂F₂: Lithium difluorophosphate

PS: 1,3-Propane sultone

ESA: 1,2-Ethylene sulfate

### Experimental Example

### Experimental Example 1: Evaluation of Initial Capacity

The lithium secondary batteries of the examples and comparative examples were charged at 0.5C-rate CC/CV (4.2V, 0.05C cut-off), and then discharged at 0.5C-rate CC (2.7V cut-off) three times, all at 25° C.

The discharge capacity values obtained at the third cycle were defined as the initial capacity of the lithium secondary batteries, and the result values are described in Table 2 below.

### Experimental Example 2: Evaluation of High-Temperature Storage Characteristics (at 60° C.)

### (1) Measurement of Capacity Retention Rate After High-Temperature Storage

The lithium secondary batteries of the examples and comparative examples were subjected to 0.5C CC/CV charge (4.2V, 0.05C cut-off) and 0.5C CC discharge (2.7V cut-off) at 25° C. three times, and the discharge capacity C1 at the third cycle was measured.

The charged lithium secondary batteries were stored at 60° C. for 4 weeks, then additionally left at room temperature for 30 minutes, followed by 0.5C CC discharging (2.75V CUT-OFF), and the discharge capacity C2 was measured. The capacity retention rate was calculated by the following equation, and the results are described in Table 2 below.

$$Capacity retention rate after high - temperature storage ( \% ) = C 2 / C 1 \times 100$$

### (2) Resistance After High-Temperature Storage

After the lithium secondary batteries of the examples and comparative examples were left under ambient exposure conditions at 60° C. for 4 weeks (using a thermostatic device), and charging and discharging were performed at each corresponding C-rate for 10 seconds, while sequentially varying the C-rate to 0.2C, 0.5C, 1.0C, 1.5C, 2.0C and 2.5C at a 60% state-of-charge (SOC) point at 25° C. Then, the terminal voltage points were plotted to construct a linear equation, and the slope of the resulting line was adopted as the DCIR.

The DCIR measured by the above method was defined as R2, and the DCIR measured by the same method, except that the battery was not left under ambient exposure conditions at 60° C. for 4 weeks, was defined as R1. The DCIR change rate was calculated as follows, and the results are shown in Table 2 below.

$$DCIR change rate ( \% ) = \{ ( R 2 - R 1 ) / R 1 + 1 \} \times 100$$

### (3) Measurement of Battery Thickness After High-Temperature Storage

The lithium secondary batteries of the examples and comparative examples were subjected to 0.5C CC/CV charge (4.2V, 0.05C cut-off) and 0.5C CC discharge (2.7V cut-off) at 25° C., then the battery thickness Tl was measured. After leaving the charged lithium secondary batteries of the examples and comparative examples under ambient exposure conditions at 60° C. for 4 weeks (using the thermostatic device), the battery thickness T2 was measured.

The battery thickness was measured using a flat thickness measuring device (Mitutoyo, 543-490B). The battery thickness change rate was calculated as follows, and the results are shown in Table 2 below.

$$Battery thickness change rate ( \% ) = \{ ( T 2 - T 1 ) / T 1 + 1 \} \times 100$$

TABLE 2

| | | Example | Example | Example | Comparative |
|---|---|---|---|---|---|
| | | 1 | 2 | 3 | Example 1 |
| Initial performance | Capacity (mAh) | 2,058 | 2,082 | 1,969 | 2,102 |
| High-temperature | Capacity retention | 84.0 | 83.1 | 83.3 | 82.2 |
| storage | rate (%) | | | | |
| characteristics | DCIR change rate | 114 | 120 | 100 | 129 |
| (at 60° C. for 4 | (%) | | | | |
| weeks) | Thickness change | 95.4 | 103 | 93.9 | 105 |
| | rate (%) | | | | |

Referring to Tables 1 and 2 above, the lithium secondary batteries of the examples using additive I, which includes the complex of a boroxine compound and pyridine, showed improved high-temperature storage characteristics (at 60° C.).

Compared to the lithium secondary batteries of the examples, the lithium secondary battery of Comparative Example 1, which did not use additive I, exhibited a low capacity retention rate and higher DCIR change rate and thickness change rate during the evaluation of the high-temperature storage characteristics (at 60° C. for 4 weeks).

The contents described above are merely examples of applying the principles of the present disclosure, and other configurations may be further included without departing from the scope of the present disclosure.

### DESCRIPTION OF REFERENCE NUMERALS

100: Cathode
105: Cathode current collector
110: Cathode active material layer
120: Anode active material layer
125: Anode current collector
130: Anode
140: Separation membrane
150: Electrode assembly
160: Case

What is claimed is:

1. An electrolyte for a lithium secondary battery comprising:
an additive which comprises a complex containing a boroxine compound;
a lithium salt; and
an organic solvent.

2. The electrolyte for a lithium secondary battery according to claim 1, wherein the boroxine compound comprises a compound having a structure represented by Formula 1 below: 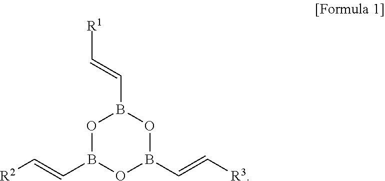
(in Formula 1, R¹ to R³ are each independently an alkyl group having 1 to 10 carbon atoms, an alkenyl group having 2 to 10 carbon atoms, an alkoxy group having 1 to 10 carbon atoms, an aryl group having 6 to 12 carbon atoms, a hydroxyl group or a hydrogen atom).

3. The electrolyte for a lithium secondary battery according to claim 2, wherein R¹ to R³ are each independently an alkyl group having 1 to 6 carbon atoms, an alkenyl group having 2 to 6 carbon atoms, an alkoxy group having 1 to 6 carbon atoms, an aryl group having 6 to 10 carbon atoms, a hydroxyl group or a hydrogen atom.

4. The electrolyte for a lithium secondary battery according to claim 2, wherein the compound having a structure represented by Formula 1 above comprises a compound having a structure represented by Formula 2 below:

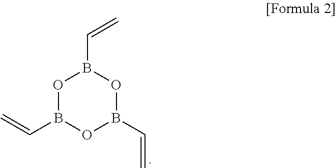

5. The electrolyte for a lithium secondary battery according to claim 1, wherein the complex further comprises a heteroaromatic amine which is bonded to the boroxine compound.

6. The electrolyte for a lithium secondary battery according to claim 5, wherein the heteroaromatic amine comprises pyridine.

7. The electrolyte for a lithium secondary battery according to claim 1, wherein the complex comprises a complex having a structure represented by Formula 3 below:

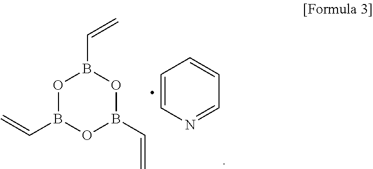

8. The electrolyte for a lithium secondary battery according to claim 1, wherein the organic solvent comprises at least one selected from the group consisting of a carbonate-based organic solvent, an ester-based organic solvent, an ether-based organic solvent, a ketone-based organic solvent and an aprotic organic solvent.

9. The electrolyte for a lithium secondary battery according to claim 1, wherein a content of the additive is 0.1% by weight to 10% by weight based on a total weight of the electrolyte.

10. The electrolyte for a lithium secondary battery according to claim 1, wherein the electrolyte further comprises at least one auxiliary additive selected from the group consisting of a cyclic carbonate compound, a fluorine-containing carbonate compound, a lithium phosphate compound, a sultone compound, a borate compound and a sulfate compound.

11. The electrolyte for a lithium secondary battery according to claim 10, wherein a content of the auxiliary additive is 0.01% by weight to 10% by weight based on the total weight of the electrolyte.

12. The electrolyte for a lithium secondary battery according to claim 1, wherein the electrolyte further comprises an auxiliary additive comprising a sultone compound and a sulfate compound.

13. A lithium secondary battery comprising:
an electrode assembly which comprises cathodes and anodes repeatedly stacked; and
the electrolyte for a lithium secondary battery according to claim 1, which is impregnated into the electrode assembly.

14. The lithium secondary battery according to claim 13, wherein the cathode comprises a cathode active material comprising a lithium metal oxide-based active material.

15. The lithium secondary battery according to claim 13, wherein the anode comprises an anode active material comprising a silicon-based active material.
